(19) United States
(12) Patent Application Publication
(10) Pub. No.: US 2006/0028456 A1
(43) Pub. Date: Feb. 9, 2006

(54) Pen-shaped optical mouse

(76) Inventor: Byung-Geun Kang, Yongin-si (KR)

Correspondence Address: OLIFF & BERRIDGE, PLC, P.O. BOX 19928, ALEXANDRIA, VA, 22320, US

(21) Appl. No.: 10/529,368

(22) PCT Filed: Aug. 20, 2003
(86) PCT No.: PCT/KR03/01674

§ 371 Date: Mar. 28, 2005

(30) Foreign Application Priority Data
Oct. 10, 2002 (KR) 10-2002-0061638
Feb. 17, 2003 (KR) 10-2002-0009747

(51) Int. Cl. G09G 5/00

(52) U.S. Cl. 345/179

(57) ABSTRACT

Disclosed is a pen-shaped optical mouse. The optical mouse has an optical fiber on the optical path of illuminating light, and an optical fiber bundle on the optical path of reflected light, respectively. The optical system of the optical mouse is realized irrespective of the optical paths and their lengths, showing a good image-transmitting feature to transmit good image to an image sensor. An image is input to the image sensor through an end of an optical tip where the image directly contacts a reflecting surface, which enhances the accuracy of the pen-shaped optical mouse since there is no change in the location of a mouse pointer or a focal length in spite of the change in the angle between the pen-shaped optical mouse and the reflecting surface.

### TECHNICAL FIELD

The present invention relates to a pen-shaped optical mouse, and more particularly to a pen-shaped optical mouse which employs an optical system operating irrespective of any optical transmission path and distance, so that it operates irrespective of its angle defined with respect to a reflection surface.

### BACKGROUND ART

In a computer, a mouse is widely used as an input device, along with a keyboard. In the case of a conventional hemispherical dome-shaped optical mouse or ball mouse, many problems caused by the structure and shape of the mouse have recently been noted in terms of usage. In order to solve such problems, efforts to provide a mouse having a pen-shaped structure familiar to the public have been made.

FIG. 1 is a schematic view explaining the operating concept of a conventional pen-shaped optical mouse.

Referring to FIG. 1, light emitted from a light emitting unit included in the pen-shaped optical mouse is reflected from a reflection surface, and is then incident to an image sensor after passing through a condenser lens and an imaging unit in a sequential manner, thereby forming an image on the image sensor. The illustrated pen-shaped optical mouse is provided with a button adapted to be clicked when the condenser lens is depressed at its tip. However, such a depression of the condenser lens results in a variation in the focal length of the condenser lens or imaging unit. For this reason, the image focused on the image sensor cannot be maintained in an optimal state. To this end, conventional pen-shaped optical mice are generally configured to have a long focal length, in order to keep the focused image in a more or less recognizable state. In this case, however, there are many limitations in designing an optical system in terms of structure and performance. In particular, there are limitations on the position of the image sensor and the space occupied by the optical system, so that it is impossible to arrange the function setting button of the mouse at a desired position. In order to solve such problems, a pressure sensor may be used in place of the function setting button. In this case, however, there are various inconveniences in that the user must determine the depression of the pressure sensor in accordance with his sense of touch. Meanwhile, such a pen-shaped optical mouse must have a shape and size (thickness) allowing the user to comfortably grasp the mouse, taking into consideration convenience in using the mouse. In the case of a pen-shaped structure simply using a lens, as in conventional pen-shaped mice, however, it is difficult to provide a mouse shape and size (thickness) desired by the user.

### DISCLOSURE OF THE INVENTION

Therefore, an object of the invention is to provide a pen-shaped optical mouse which eliminates disadvantages involved with conventional pen-shaped optical mice in terms of usage by employing an optical system having a new structure.

Another object of the invention is to provide a pen-shaped optical mouse which can be reliably used irrespective of the angle of a reflection surface.

In accordance with one embodiment for accomplishing the above mentioned objects, the present invention provides a pen-shaped optical mouse for displaying a pointer or cursor on a computer monitor at a desired position in accordance with a movement thereof detected using a reflected light, the optical mouse comprising: a pen-shaped mouse body; a transparent optical tip member mounted to one end of the mouse body; an illuminating unit mounted in the mouse body, and adapted to irradiate light through the optical tip member onto a reflection surface arranged outside the mouse body, the illuminating unit including a light emitter, an optical fiber for guiding light emitted from the light emitter, and a prism arranged at an output end of the optical fiber; a condenser lens mounted in the mouse body, and adapted to allow light reflected from the reflection surface to pass therethrough; a bundle optical fiber for guiding the light passing through the condenser lens; an imaging unit for receiving the light emerging from the bundle optical fiber, thereby forming an image; an image sensor for receiving light outputted from the imaging unit, converting the received light into an electrical signal; and a microcomputer for analyzing pattern information of the reflection surface inputted to the image sensor, based on the electrical signal outputted from the image sensor, detecting a moving direction and distance of the mouse, based on the analyzed pattern information, and transmitting information about the moving direction and distance to a computer body.

In accordance with another embodiment for accomplishing the above mentioned objects, the present invention provides a pen-shaped optical mouse for displaying a pointer or cursor on a computer monitor at a desired position in accordance with a movement thereof detected using a reflected light, the optical mouse comprising: a pen-shaped mouse body; a transparent optical tip member mounted to one end of the mouse body; an illuminating unit mounted in the mouse body, and adapted to irradiate light onto a reflection surface arranged outside the mouse body, the illuminating unit including a light emitter, an optical fiber for guiding light emitted from the light emitter, and a prism arranged at an output end of the optical fiber; a condenser lens mounted in the mouse body, and adapted to allow light reflected from the reflection surface to pass therethrough via the optical tip member; a bundle optical fiber for guiding the light passing through the condenser lens; an imaging unit for receiving the light emerging from the bundle optical fiber, thereby forming an image; an image sensor for receiving light outputted from the imaging unit, converting the received light into an electrical signal; and a microcomputer for analyzing pattern information of the reflection surface inputted to the image sensor, based on the electrical signal outputted from the image sensor, detecting a moving direction and distance of the mouse, based on the analyzed pattern information, and transmitting information about the moving direction and distance to a computer body.

In accordance with another embodiment for accomplishing the above mentioned objects, the present invention provides a pen-shaped optical mouse for displaying a pointer or cursor on a computer monitor at a desired position in accordance with a movement thereof detected using a reflected light, the optical mouse comprising: a pen-shaped mouse body; a ball rotatably fitted in one end of the mouse body, the ball having a pattern on a surface thereof; an illuminating unit mounted in the mouse body, and adapted to irradiate light onto the ball, the illuminating unit including a light emitter, an optical fiber for guiding light emitted from the light emitter, and a prism arranged at an output end of the optical fiber; a condenser lens mounted in the mouse body, and adapted to allow light reflected from the ball to pass therethrough; a bundle optical fiber for guiding the light passing through the condenser lens; an imaging unit for receiving the light emerging from the bundle optical fiber, thereby forming an image; an image sensor for receiving light outputted from the imaging unit, converting the received light into an electrical signal; and a microcomputer for analyzing pattern information of the ball surface inputted to the image sensor, based on the electrical signal outputted from the image sensor, detecting a moving direction and distance of the mouse, based on the analyzed pattern information, and transmitting information about the moving direction and distance to a computer body.

In each of the above described embodiments, the light emitter may be comprise an LED.

In each of the above described embodiments, the pen-shaped optical mouse may further comprise a wheel button sensor adapted to perform a scroll function, the wheel button sensor including a wheel fitted in an opening formed at a side wall of the mouse body such that it is rotatable about an axis thereof, while being partially protruded from the opening in an outward direction of the mouse body, the wheel having a plurality of through holes extending axially throughout the thickness of the wheel while being circumferentially arranged, a light emitter mounted in the mouse body, and adapted to irradiate light onto the wheel, and an optical sensor adapted to receive light beams from the light emitter passing through respective through holes of the wheel, thereby detecting a rotating direction and angle of the wheel. Alternatively, the pen-shaped optical mouse may further comprise a contact button sensor adapted to perform a scroll function, the contact button sensor including a transparent button mounted to a side wall of the mouse body such that it can be touched by a finger of the user grasping the mouse, a light emitter mounted in the mouse body, and adapted to irradiate light through the transparent button onto the user's finger touching the transparent button, an optical fiber adapted to receive light passing through the transparent button after being reflected from the user's finger, and to guide the reflected light to a position sensor, and the position sensor adapted to detect motion of the user's finger, based on light information received thereto via the optical fiber.

In each of the above described embodiments, the pen-shaped optical mouse may further a first click button adapted to sense a depression of the optical tip member, the first click button being clicked when it senses the depression of the optical tip member; and a second click button mounted to an outer surface of the mouse body such that it is clicked when it is depressed by a user's finger. In this case, the pen-shaped optical mouse may further comprise a wheel button sensor adapted to perform a scroll function, the wheel button sensor including a wheel fitted in an opening formed at a side wall of the mouse body such that it is rotatable about an axis thereof, while being partially protruded from the opening in an outward direction of the mouse body, the wheel having a plurality of through holes extending axially throughout the thickness of the wheel while being circumferentially arranged, the wheel being always urged by a spring such that it is inwardly retracted into the mouse body against an elastic force of the spring when it is depressed, while being outwardly protruded from the mouse body by virtue of the elastic force of the spring, so that it returns to its original state, a light emitter mounted in the mouse body, and adapted to irradiate light onto the wheel, and an optical sensor adapted to receive light beams from the light emitter passing through respective through holes of the wheel, thereby detecting a rotating direction and angle of the wheel. The first click button is arranged to be clicked when the wheel is depressed. Alternatively, the pen-shaped optical mouse may further comprise a contact button sensor adapted to perform a scroll function, the contact button sensor including a transparent button mounted to a side wall of the mouse body such that it can be touched by a finger of the user grasping the mouse, the transparent button being always urged by a spring such that it is inwardly retracted into the mouse body against an elastic force of the spring when it is depressed, while being outwardly protruded from the mouse body by virtue of the elastic force of the spring, so that it returns to its original state, a light emitter mounted in the mouse body, and adapted to irradiate light through the transparent button onto the user's finger touching the transparent button, an optical fiber adapted to receive light passing through the transparent button after being reflected from the user's finger, and to guide the reflected light to a position sensor, and the position sensor adapted to detect motion of the user's finger, based on light information received thereto via the optical fiber. The first click button is arranged to be clicked when the transparent button is depressed.

### BRIEF DESCRIPTION OF THE DRAWINGS

The above objects, and other features and advantages of the present invention will become more apparent after reading the following detailed description when taken in conjunction with the drawings, in which:

FIG. 1 is a schematic view for explaining the operating concept of a conventional pen-shaped optical mouse; and

FIG. 2A to FIG. 4 are views illustrating pen-shaped optical mice according to various embodiments of the present invention, respectively.

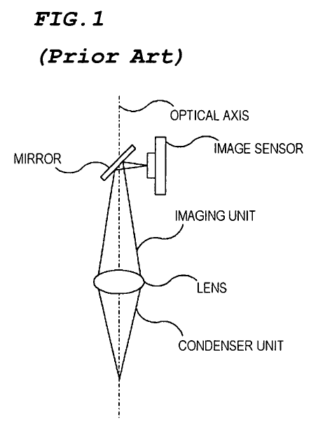

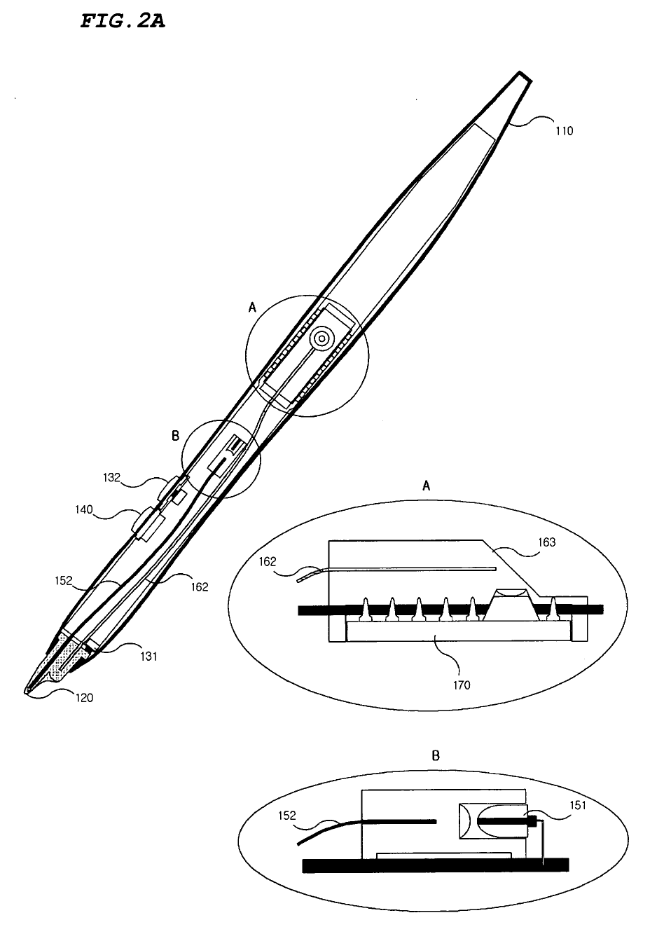

### BEST MODE FOR CARRYING OUT THE INVENTION

Now, preferred embodiments of the present invention will be described in detail with reference to the annexed drawings.

### Embodiment 1

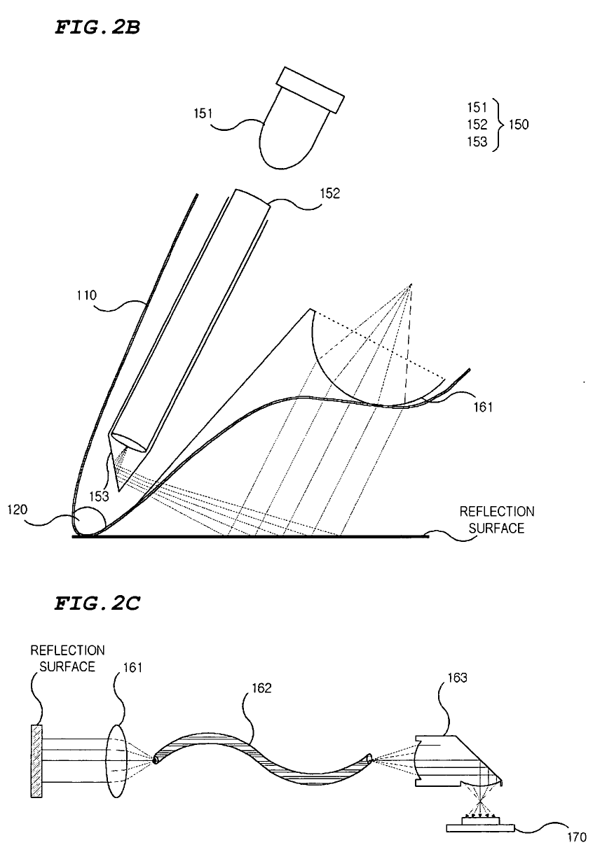

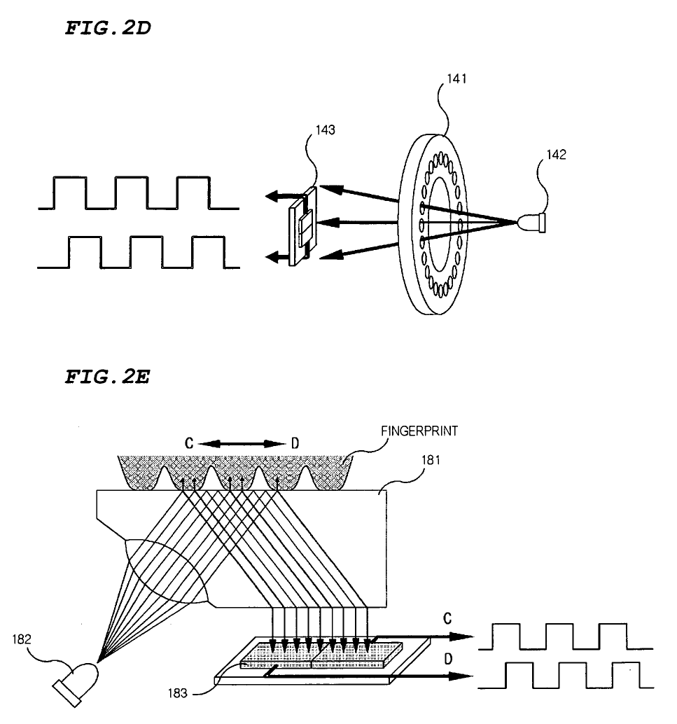

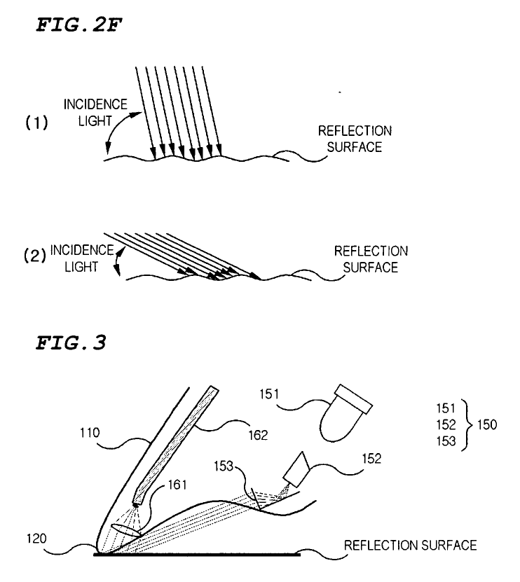

FIGS. 2A to 2F are views illustrating a pen-shaped optical mouse according to a first embodiment of the present invention, respectively.

Referring to FIG. 2A to 2C, the pen-shaped optical mouse according to the first embodiment of the present invention includes a mouse body 110, along with an optical tip member 120, first and second click buttons 131 and 132, a wheel button sensor 140 or contact button sensor, an illuminating unit 150, a condenser lens 161, a bundled optical fiber 162, an imaging unit 163, an image sensor 170, and a microcomputer (not shown), all of which are installed in the mouse body 110.

The mouse body 110 has the shape of a pen which is a writing instrument most familiar to the public. Since the mouse of the present invention has such a pen shape, the user does not feel fatigued even after using the mouse. Also, the mouse can be conveniently carried by the user, and easily used even in a narrow space, while having excellent functions in association with accurate drawing or writing tasks or writing of italic letters.

The optical tip member 120 is made of a transparent material. The optical tip member 120 is installed to be always urged by a spring such that it is inwardly moved into the mouse body 110 against the elastic force of the spring when it is depressed against a reflection surface, while being outwardly moved from the mouse body 110 by virtue of the elastic force of the spring when the depression is released, so that it returns to its original state. The optical tip member 120 is supported by a holder (not shown) so that it does not move laterally.

The first click button 131, which corresponds to a left click button in a conventional mouse, is installed in the mouse body 110 such that it is clicked when the optical tip member 120 is inwardly moved into the mouse body 110. The second click button 132, which corresponds to a right click button in a conventional mouse, is installed on the outer surface of the mouse body 110 such that it is clicked when it is depressed by a finger of the user. Generally, a spring may be used for the clicking operation of the first click button 131. Alternatively, a pressure sensor may be used in place of the spring. In this case, the pressure sensor senses depression of the optical tip member 120, thereby enabling the first click button 131 to be clicked.

Referring to FIG. 2D along with FIG. 2B, the wheel button sensor 140 includes a wheel 141, a light emitter 142, and an optical sensor 143, so as to perform a scroll function.

The wheel 141 is provided with a plurality of through holes extending axially throughout the thickness of the wheel 141 while being circumferentially arranged. The wheel 141 is fitted in an opening formed at a side wall of the mouse body 110 such that it is rotatable about its axis, while being partially protruded from the opening in an outward direction of the mouse body 110. The light emitter 142 is installed in the mouse body 110, and adapted to irradiate light onto the wheel 141. The optical sensor 143 receives light beams passing through respective through holes of the wheel 141, and converts the received light beams into electrical signals having different phases, respectively. Based on the electrical signals, the optical sensor 143 detects the rotating direction and angle of the wheel 141. In addition to the rotating configuration thereof, the wheel 141 is also configured to be always urged by a spring such that it is inwardly retracted into the mouse body 110 against the elastic force of the spring when it is depressed, while being outwardly protruded from the mouse body 110 by virtue of the elastic force of the spring, so that it returns to its original state. The wheel 141 may also be configured to click the first click button 131 when it is inwardly moved into the mouse body 110 as it is depressed, so that a desired function is performed which corresponds to the function performed when the left click button of a conventional mouse is clicked.

Meanwhile, there is a limitation in miniaturizing the size of the wheel 141 included in the wheel button sensor 140. This limitation hinders a miniaturization of the pen-shaped optical mouse. Accordingly, a contact button sensor may be employed which can perform the same function as the scroll function of the wheel button sensor 140.

Referring to FIG. 2E along with FIG. 2A, the contact button sensor 180 includes a transparent button 181, a light emitter 182, an optical fiber (not shown), and a position sensor 183.

The transparent button 181 is mounted to the side wall of the mouse body 110 such that it can be touched by a finger of the user grasping the mouse. The light emitter 182 is mounted in the mouse body 110, and adapted to irradiate light through the transparent button 181 onto the user's finger touching the transparent button 181. The optical fiber receives light passing through the transparent button 181 after being reflected from the user's finger, and guides the reflected light to the position sensor 183. The position sensor 183 detects motion of the user's finger, based on light information received thereto via the optical fiber. The transparent button 181 is configured to be always urged by a spring such that it is inwardly retracted into the mouse body 110 against the elastic force of the spring when it is depressed, while being outwardly protruded from the mouse body 110 by virtue of the elastic force of the spring, so that it returns to its original state. The transparent button 181 may also be configured to click the first click button 131 when it is inwardly moved into the mouse body 110 as it is depressed, so that a desired function is performed which corresponds to the function performed when the left click button of a conventional mouse is clicked.

Since the user's finger has a fingerprint, the light reflected from the user's finger has a particular pulse waveform. This particular pulse waveform has a particular phase in accordance with the moving direction of the finger contacting the transparent button 181. Accordingly, the contact button sensor 180 can determine the scrolling direction of the finger by detecting the phase of the pulse waveform.

The first click button 131, second click button 132, wheel 141 and transparent button 181 operate in the same fashion as those of a conventional mouse. That is, the pen-shaped optical mouse of the present invention can select a desired icon on a display screen by depressing the optical tip member 120 on to the reflection surface or depressing the wheel 141 or transparent button 181 by use of the user's finger, and then depressing the second click button 132, thereby displaying a pop-up menu window on the display screen, so as to allow the user to select functions displayed on the pop-up menu. Of course, it is possible to vertically scroll the picture displayed on the display screen, by use of the wheel 141 or transparent button 181.

Referring to FIGS. 2A to 2C again, the illuminating unit 150 functions to irradiate, through the optical tip member 120, light onto a reflection surface arranged outside the mouse body 110. For this function, the illuminating unit 150 includes a light emitter 151, an optical fiber 152 for guiding light emitted from the light emitter 151, and a prism 153 arranged at an output end of the optical fiber 152. For the light emitter 151, a light emitting diode (LED) or electro luminescent (EL) element may be used.

The optical mouse having the above described configuration reads light irregularly reflected from a reflection surface having irregularity patterns after being emitted from the illuminating unit 150, by the image sensor 170, thereby sensing the irregularity patterns of the reflection surface. In such a manner, the optical mouse measures a variation of the sensed irregularity patterns caused by a movement thereof, thereby measuring the moving direction and distance thereof.

FIG. 2F illustrates usage examples of a pen-shaped optical mouse at different incidence angles of light onto a reflection surface, for example, a general paper sheet such as a copier sheet or the surface of a desk, respectively. The figure (1) in FIG. 2F shows the case in which light is incident onto the reflection surface at a large incidence angle, whereas the figure (2) in FIG. 2F shows the case in which light is incident onto the reflection surface at a small incidence angle. Referring to FIG. 2F, it can be seen that the image sensor can more accurately identify the irregularity patterns of the reflection surface at the small incidence angle because the area receiving the incident light at the small incidence angle is smaller than that at the large incidence angle, so that the number of irregularity patterns reflecting the incident light is reduced.

To this end, in the pen-shaped optical mouse according to the illustrated embodiment of the present invention, the illuminating unit 150 is arranged such that the light irradiated therefrom is incident onto the reflection surface at an incidence angle of 14 to 21° when the optical mouse forms an angle of 40 to 70° with respect to the reflection surface.

Referring to FIGS. 2A to 2C again, the light irradiated onto the reflection surface is reflected from the reflection surface, so that it enters the mouse body 110. Thereafter, the light sequentially passes through the condenser lens 161, bundle optical fiber 162, and imaging unit 163, and then reaches the image sensor 170.

The condenser lens 161 serves to make the light introduced into the mouse body 110 be well condensed into the bundle optical fiber 162. The bundle optical fiber 162 transfers the light passing though the condenser lens 161 to the imaging unit 163 without any distortion in accordance with its image guiding characteristics. The imaging unit 163 includes an imaging lens adapted to accurately focus the light emerging from the bundle optical fiber 162 onto the image sensor 170. The bundle optical fiber 162 is fixedly mounted to the condenser lens 161 and the imaging unit 163 at opposite ends thereof by means of supporting members, respectively, in order to stably guide the light incident thereto.

As described above in conjunction with the related art, the conventional pen-shaped optical mouse has a problem in measuring the coordinate values of a pointer or cursor because the distance from the reflection surface to the image sensor varies when the first click button is clicked in accordance with a depression of the optical tip member. In accordance with the present invention, however, it is possible to accurately measure the coordinate values of a pointer or cursor. That is, although the straight distance from the reflection surface to the image sensor 170 varies when the optical tip member 120 is depressed, the length of the bundle optical fiber 162 does not vary. The bundle optical fiber 162 is simply bent, because it is flexible. Accordingly, the bundle optical fiber 162 is not influenced by the variation of the distance from the reflection surface to the image sensor 170. Thus, the coordinate values of the pointer or cursor can be accurately measured.

The image sensor 170 receives light emerging from the imaging unit 163, and converts the received light into an electrical signal. For the image sensor 170, a CMOS sensor or charge coupled device (CCD) may be used. Where the CMOS sensor is used, there is an advantage in that the CMOS sensor can be packaged, along with a microcomputer, into a single chip. The microcomputer (not shown) analyzes the information about the irregularity pattern of the reflection surface inputted to the image sensor 170, based on the electrical signal outputted from the image sensor 170, thereby identifying the moving direction and distance of the mouse. The microcomputer then sends the identified information to a computer (not shown) connected thereto.

Meanwhile, the imaging unit 163 and image sensor 170 may have optical axes aligned with each other, respectively. Alternatively, the imaging unit 163 may include a mirror, and an imaging lens, so as to refract light incident thereto. In this case, the image sensor 170 is arranged to receive the refracted light. The optical arrangement of the imaging unit 163 and image sensor 170 may be appropriately selected, taking into consideration the size and thickness of the optical mouse.

### Embodiment 2

FIG. 3 is a schematic view illustrating a pen-shaped optical mouse according to a second embodiment of the present invention.

The pen-shaped optical mouse according to the second embodiment of the present invention includes a mouse body, along with an optical tip member, click buttons, a wheel button sensor or contact button sensor, an illuminating unit, a condenser lens, a bundled optical fiber, an imaging unit, an image sensor, and a microcomputer, all of which are installed in the mouse body. This pen-shaped optical mouse has the same configuration as that of the first embodiment, except for the mounted positions of the illuminating unit and condenser lens. Accordingly, no further description will be given with respect to the identically configured elements.

Referring to FIG. 3 along with FIG. 2A, the illuminating unit 150 of the pen-shaped optical mouse according to this embodiment is arranged such that light illuminated therefrom is directly irradiated onto a reflection surface without passing through the optical tip member 120. The condenser lens 161 is arranged in the optical tip member 120 such that the light reflected from the reflection surface passes therethrough after emerging from the optical tip member 120. In this embodiment, the illuminating unit 150 is also arranged such that where the pen-shaped optical mouse forms an angle of 40 to 70° with respect to the reflection surface, the light illuminated from the illuminating unit 151 is incident onto the reflection surface at an incidence angle of 14 to 21°. The bundle optical fiber 162 is fixedly mounted to the condenser lens 161 and the imaging unit 163 at opposite ends thereof by means of supporting members, respectively.

In accordance with the above described arrangements in this embodiment, there is no variation in the position of the pointer or cursor or focal length even when the angle between the pen-shaped optical mouse and the reflection surface varies more or less, in so far as there is no lateral movement of the optical tip member 120 at its tip, because an optical image is inputted from the tip of the optical tip member 120, directly contacting the reflection surface, to the image sensor 170. Thus, the pen-shaped optical mouse can be used with enhanced accuracy.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

### Embodiment 3

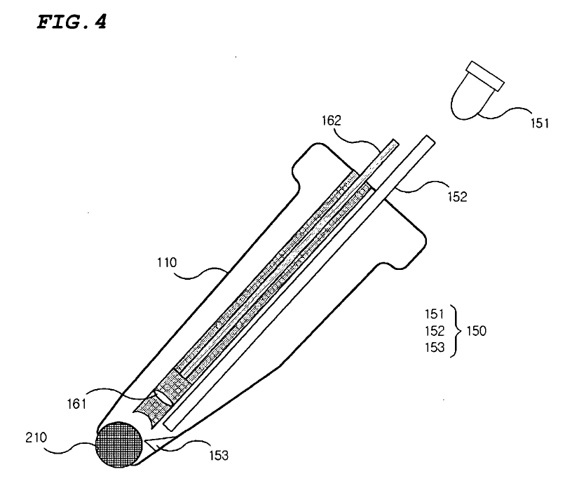

FIG. 4 is a schematic view illustrating a pen-shaped optical mouse according to a third embodiment of the present invention.

The pen-shaped optical mouse according to the third embodiment of the present invention includes a mouse body, along with a ball, click buttons, a wheel button sensor or contact button sensor, an illuminating unit, a condenser lens, a bundled optical fiber, an imaging unit, an image sensor, and a microcomputer, all of which are installed in the mouse body. This pen-shaped optical mouse has the same configuration as that of the first embodiment, except that it includes the ball, in place of the optical tip member, so that the position of the region where light from the illuminating unit is irradiated, and the mounted position of the condenser lens are different from those of the first embodiment. Accordingly, no further description will be given with respect to the same configuration.

Referring to FIG. 4 along with FIG. 2A, the ball 210 has a certain pattern on its surface. The ball 210 is fitted in one end of the mouse body 110 such that it is rotatable. That is, the ball 210 is rotatably arranged at the position where the optical tip member 120 of the optical mouse according to the first embodiment is arranged.

The illuminating unit 150 is arranged such that it radiates light onto the ball 210. Similarly to the first embodiment, the illuminating unit 150 includes a light emitter 151, an optical fiber 152 for guiding light emitted from the light emitter 151, and a prism 153 installed at an output end of the optical fiber 152.

The condenser lens 161 is arranged such that light reflected from the surface of the ball 210 passes therethrough. The bundle optical fiber 162 is fixedly mounted to the condenser lens 161 and the imaging unit 163 at opposite ends thereof by means of supporting members, respectively.

In accordance with the above described arrangements in this embodiment, the ball 210 fitted in one end of the mouse body 110 rotates when the pen-shaped optical mouse moves while coming into contact with a certain surface. As a result, the image sensor 170 recognizes the pattern formed on the surface of the ball 210, via the condenser lens 161, bundle optical fiber 162, and imaging unit 163. Based on the recognized ball pattern, it is possible to detect the moving direction of the mouse. In this case, the moving direction of the mouse can be detected in so far as the ball 210 rotates. Accordingly, there is an advantage in that the optical mouse can be reliably used, irrespective of its angle defined with respect to a reflection surface.

### INDUSTRIAL APPLICABILITY

As apparent from the above description, in accordance with the present invention, it is possible to implement a pen-shaped optical mouse using an optical system configured to transmit light through a bundle optical fiber without any influence by the distance from a reflection surface to an image sensor included in the mouse, and an optical transmission path defined in the mouse, so that it achieves a superior image transmission performance irrespective of the structure of the optical system, thereby being capable of transmitting an image having a good picture quality to the image sensor.

In accordance with the present invention, it is possible to input an image from the tip of an optical tip member, coming into direct contact with a reflection surface, to the image sensor. Accordingly, the position of a mouse pointer or cursor or focal length does not vary even when the angle of the pen-shaped optical mouse formed with respect to the reflection surface varies more or less. As a result, it is possible to use the pen-shaped optical mouse with an enhanced accuracy.

Furthermore, the pen-shaped optical mouse may include a ball rotatably fitted in an end of the mouse body while having a particular pattern. In this case, it is possible to detect the moving direction of the optical mouse, based on light reflected from the ball. Thus, the optical mouse can be reliably used, irrespective of its angle defined with respect to the reflection surface.

1. A pen-shaped optical mouse for displaying a pointer or cursor on a computer monitor at a desired position in accordance with a movement thereof detected using a reflected light, the optical mouse comprising:
a pen-shaped mouse body;
a transparent optical tip member mounted to one end of the mouse body;
an illuminating unit mounted in the mouse body, and adapted to irradiate light through the optical tip member onto a reflection surface arranged outside the mouse body, the illuminating unit including a light emitter, an optical fiber for guiding light emitted from the light emitter, and a prism arranged at an output end of the optical fiber;
a condenser lens mounted in the mouse body, and adapted to allow light reflected from the reflection surface to pass therethrough;
a bundle optical fiber for guiding the light passing through the condenser lens;
an imaging unit for receiving the light emerging from the bundle optical fiber, thereby forming an image;
an image sensor for receiving light outputted from the imaging unit, converting the received light into an electrical signal; and
a microcomputer for analyzing pattern information of the reflection surface inputted to the image sensor, based on the electrical signal outputted from the image sensor, detecting a moving direction and distance of the mouse, based on the analyzed pattern information, and transmitting information about the moving direction and distance to a computer body.

2. A pen-shaped optical mouse for displaying a pointer or cursor on a computer monitor at a desired position in accordance with a movement thereof detected using a reflected light, the optical mouse comprising:
a pen-shaped mouse body;
a transparent optical tip member mounted to one end of the mouse body;
an illuminating unit mounted in the mouse body, and adapted to irradiate light onto a reflection surface arranged outside the mouse body, the illuminating unit including a light emitter, an optical fiber for guiding light emitted from the light emitter, and a prism arranged at an output end of the optical fiber;
a condenser lens mounted in the mouse body, and adapted to allow light reflected from the reflection surface to pass therethrough via the optical tip member;
a bundle optical fiber for guiding the light passing through the condenser lens;
an imaging unit for receiving the light emerging from the bundle optical fiber, thereby forming an image;
an image sensor for receiving light outputted from the imaging unit, converting the received light into an electrical signal; and
a microcomputer for analyzing pattern information of the reflection surface inputted to the image sensor, based on the electrical signal outputted from the image sensor, detecting a moving direction and distance of the mouse, based on the analyzed pattern information, and transmitting information about the moving direction and distance to a computer body.

3. A pen-shaped optical mouse for displaying a pointer or cursor on a computer monitor at a desired position in accordance with a movement thereof detected using a reflected light, the optical mouse comprising:
a pen-shaped mouse body;
a ball rotatably fitted in one end of the mouse body, the ball having a pattern on a surface thereof;
an illuminating unit mounted in the mouse body, and adapted to irradiate light onto the ball, the illuminating unit including a light emitter, an optical fiber for guiding light emitted from the light emitter, and a prism arranged at an output end of the optical fiber;
a condenser lens mounted in the mouse body, and adapted to allow light reflected from the ball to pass therethrough;
a bundle optical fiber for guiding the light passing through the condenser lens;
an imaging unit for receiving the light emerging from the bundle optical fiber, thereby forming an image;
an image sensor for receiving light outputted from the imaging unit, converting the received light into an electrical signal; and
a microcomputer for analyzing pattern information of the ball surface inputted to the image sensor, based on the electrical signal outputted from the image sensor, detecting a moving direction and distance of the mouse, based on the analyzed pattern information, and transmitting information about the moving direction and distance to a computer body.

4. The pen-shaped optical mouse according to any one of claims 1 to 3, wherein the light emitter comprises an LED.

5. The pen-shaped optical mouse according to any one of claims 1 to 3, wherein the imaging unit and image sensor have optical axes aligned with each other, respectively.

6. The pen-shaped optical mouse according to any one of claims 1 to 3, wherein:
the imaging unit is arranged such that it refracts the light received thereto; and
the image sensor is arranged such that it receives the refracted light from the imaging unit.

7. The pen-shaped optical mouse according to any one of claims 1 to 3, further comprising:
a first click button adapted to sense a depression of the optical tip member, the first click button being clicked when it senses the depression of the optical tip member; and
a second click button mounted to an outer surface of the mouse body such that it is clicked when it is depressed by a user's finger.

8. The pen-shaped optical mouse according to any one of claims 1 to 3, further comprising a wheel button sensor adapted to perform a scroll function, the wheel button sensor including:
a wheel fitted in an opening formed at a side wall of the mouse body such that it is rotatable about an axis thereof, while being partially protruded from the opening in an outward direction of the mouse body, the wheel having a plurality of through holes extending axially throughout the thickness of the wheel while being circumferentially arranged;
a light emitter mounted in the mouse body, and adapted to irradiate light onto the wheel; and
an optical sensor adapted to receive light beams from the light emitter passing through respective through holes of the wheel, thereby detecting a rotating direction and angle of the wheel.

9. The pen-shaped optical mouse according to claim 7, further comprising a wheel button sensor adapted to perform a scroll function, the wheel button sensor including:
a wheel fitted in an opening formed at a side wall of the mouse body such that it is rotatable about an axis thereof, while being partially protruded from the opening in an outward direction of the mouse body, the wheel having a plurality of through holes extending axially throughout the thickness of the wheel while being circumferentially arranged, the wheel being always urged by a spring such that it is inwardly retracted into the mouse body against an elastic force of the spring when it is depressed, while being outwardly protruded from the mouse body by virtue of the elastic force of the spring, so that it returns to its original state;
a light emitter mounted in the mouse body, and adapted to irradiate light onto the wheel; and
an optical sensor adapted to receive light beams from the light emitter passing through respective through holes of the wheel, thereby detecting a rotating direction and angle of the wheel,
wherein the first click button is arranged to be clicked when the wheel is depressed.

10. The pen-shaped optical mouse according to any one of claims 1 to 3, further comprising a contact button sensor adapted to perform a scroll function, the contact button sensor including:
a transparent button mounted to a side wall of the mouse body such that it can be touched by a finger of the user grasping the mouse;
a light emitter mounted in the mouse body, and adapted to irradiate light through the transparent button onto the user's finger touching the transparent button;
an optical fiber adapted to receive light passing through the transparent button after being reflected from the user's finger, and to guide the reflected light to a position sensor; and
the position sensor adapted to detect motion of the user's finger, based on light information received thereto via the optical fiber.

11. The pen-shaped optical mouse according to claim 7, further comprising a contact button sensor adapted to perform a scroll function, the contact button sensor including:
a transparent button mounted to a side wall of the mouse body such that it can be touched by a finger of the user grasping the mouse, the transparent button being always urged by a spring such that it is inwardly retracted into the mouse body against an elastic force of the spring when it is depressed, while being outwardly protruded from the mouse body by virtue of the elastic force of the spring, so that it returns to its original state;
a light emitter mounted in the mouse body, and adapted to irradiate light through the transparent button onto the user's finger touching the transparent button;
an optical fiber adapted to receive light passing through the transparent button after being reflected from the user's finger, and to guide the reflected light to a position sensor; and
the position sensor adapted to detect motion of the user's finger, based on light information received thereto via the optical fiber,
wherein the first click button is arranged to be clicked when the transparent button is depressed.

12. The pen-shaped optical mouse according to claim 1 or 2, wherein the illuminating unit is arranged such that the light irradiated therefrom is incident onto the reflection surface at an incidence angle of 14 to 21° when the optical mouse forms an angle of 40 to 70° with respect to the reflection surface.
